(19) United States
(12) Patent Application Publication
(10) Pub. No.: US 2007/0100960 A1
(43) Pub. Date: May 3, 2007

(54) Managing content for RSS alerts over a network

(75) Inventors: Matthias Eichstaedt, Sunnyvale, CA (US); Yunzhong Chen, San Jose, CA (US); Michael R. Cook, San Jose, CA (US); Ronald W. Ludwig, Tracy, CA (US); Sotirios Matzanas, San Francisco, CA (US); Kamlesh C. Pandey, Sunnyvale, CA (US); Adam Prishtina, San Jose, CA (US); Stephen W. Swales, Sunnyvale, CA (US)

Correspondence Address: DARBY & DARBY P.C., P.O. BOX 5257, NEW YORK, NY, 10150-6257, US

(73) Assignee: Yahoo! Inc., Sunnyvale, CA (US)

(21) Appl. No.: 11/262,503

(22) Filed: Oct. 28, 2005

(51) Int. Cl. G06F 15/16

(52) U.S. Cl. 709/217

(57) ABSTRACT

A system, apparatus, and method are directed to managing an alert to a subscriber based on a change of content at an RSS content source (RCS). A content collector identifies changes in content from various RCSs. In one embodiment, the RCS may notify the content collector of a change in content. In another embodiment, a crawler is used to identify an RCS with changed content based, in part, on a subscriber's request. Information about the RCS with changed content is provided to at least one of a plurality of matching engines using a load-balancing mechanism. Each of the matching engines manages a store that identifies subscribers that have requested an alert from a particular RCS. The matching engines further determine when the subscriber was last notified of a change in content from that RCS so that the subscriber is not notified multiple times of the same change.

### FIELD OF THE INVENTION

The present invention relates generally to messaging over a network, and more particularly, but not exclusively, to a system and method for managing network messages, such as Really Simple Syndication (RSS) alerts to a user over a network.

### BACKGROUND OF THE INVENTION

The amount of readily available content available to a user over a network, such as the Internet, has increased almost exponentially for the past several decades. Moreover, there is little indication that this rate of increase in available content will not continue in the foreseeable future. Providers of such content include blogs, news sources, sports sources, weather sources, libraries, friends, universities, businesses, and the like. Many of these content providers provide new or changed content almost regularly.

Because of the large amount of changing content, users often seek mechanisms that help them manage notifications of such changes. One such mechanism uses a Really Simple Syndication (RSS) feed. Generally, RSS provides web content or summaries of web content together with links to the full versions of the content, and other meta-data. This information is delivered as an XML file typically called an RSS feed, webfeed, RSS stream, or RSS channel. RSS feeds enable a user to subscribe to a content provider's website, or the like, and receive an alert indicating when a change to the content has occurred. However, as the number of RSS feeds available over a network increases, a subscriber may become increasingly overwhelmed. Also, managing large numbers of RSS feeds for potentially millions of subscribers has become a particularly cumbersome and difficult challenge.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Description of the Invention, which is to be read in association with the accompanying drawings, wherein:

FIG. 1 shows a functional block diagram illustrating one embodiment of an environment for practicing the invention;

FIG. 2 shows one embodiment of a server device that may be included in a system implementing the invention;

FIG. 3 shows one embodiment of a match table for use in managing RSS feeds to a subscriber;

FIG. 4 illustrates a logical flow diagram generally showing one embodiment of an overview process for managing an RSS alert to a plurality of subscribers over a network;

FIG. 5 illustrates a logical flow diagram generally showing one embodiment of a process for collecting an RSS feed's content update; and

FIG. 6 illustrates a logical flow diagram generally showing one embodiment of a process for determining whether to send an RSS alert to a subscriber along with an RSS feed's content update, in accordance with the present invention.

### DETAILED DESCRIPTION OF THE INVENTION

The present invention now will be described more fully hereinafter with reference to the accompanying drawings, which form a part hereof, and which show, by way of illustration, specific exemplary embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. Accordingly, the present invention may take the form of an entirely hardware embodiment, an entirely software embodiment or an embodiment combining software and hardware aspects. The following detailed description is, therefore, not to be taken in a limiting sense.

Throughout the specification and claims, the following terms take the meanings explicitly associated herein, unless the context clearly dictates otherwise. The phrase “in one embodiment” as used herein does not necessarily refer to the same embodiment, though it may. The phrase “in another embodiment” as used herein does not necessarily refer to a different embodiment, although it may. As used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

As used herein, the term RSS refers to any of a family of file formats and associated mechanisms usable to enable a user to subscribe to and receive network syndicated content from a content provider over a network. Typically, the file format that is employed is XML, however, the invention is not so limited, and other file formats may be used. Syndicated content includes, but is not limited to such content as news feeds, events listings, news stories, blog content, headlines, project updates, excerpts from discussion forums, or even corporate information. The abbreviation RSS as used herein includes at least the following: Rich Site Summary, RDF Site Summary, and Really Simple Syndication. Furthermore, although RSS is described, the invention is not limited to RSS. For example, Atom, a syndication specification adopted by the Internet Engineering Task Force (IETF) may also be employed. As used throughout this application, including the claims, RSS refers to RSS, Atom, and other syndication file formats derived therefrom. Moreover, as used herein, the terms “feed,” and “RSS feed,” sometimes called a channel, refers to any mechanism that enables content notification and/or content access from an RSS content source (RCS). Thus, as used herein, a feed mechanism may include a push mechanism, a pull mechanism, or even a query mechanism. In one embodiment, an RSS feed may represent a summary of content formatted in an RSS format and available for access. Moreover, an RCS may provide more than one feed.

Briefly stated, the present invention is directed towards a system, method, and apparatus for managing an alert to a plurality of subscribers based on a change of content at a network site associated with an RCS. A content collector identifies a change in content from an RSS feed. In one embodiment, the RSS feed may notify the content collector of a change in content. In another embodiment, a crawler is used to identify an RSS feed with changed content based, in part, on a subscriber's request. For example, a subscriber may provide information through a query, a Uniform Resource Locator (URL), a known network address, or the like, that may be employed to identify an RSS feed for which the subscriber has requested to receive an alert about a change in content provided by its RCS. Information about the RSS feed with changed content is provided to at least one of a plurality of matching engines using a load-balancing mechanism. The load-balancing mechanism can employ one or more methods including, but not limited to, round-robin, hops, latency, priority, bandwidth, capacity, and the like. In one embodiment, the information about the RSS feed includes an RSS feed identifier, such as an RSS URL, or the like. Each of the matching engines manages a store that identifies subscribers that have requested notice of a content change from an RSS feed. In one embodiment, the store includes a list of RSS URLs for which at least one subscriber has requested notification of a change in its content. The matching engines further determine when an alert was last sent indicating a change in content for the RSS feed, based, on the RSS URL, so that duplicate alerts are not sent for the content change.

Illustrative Operating Environment

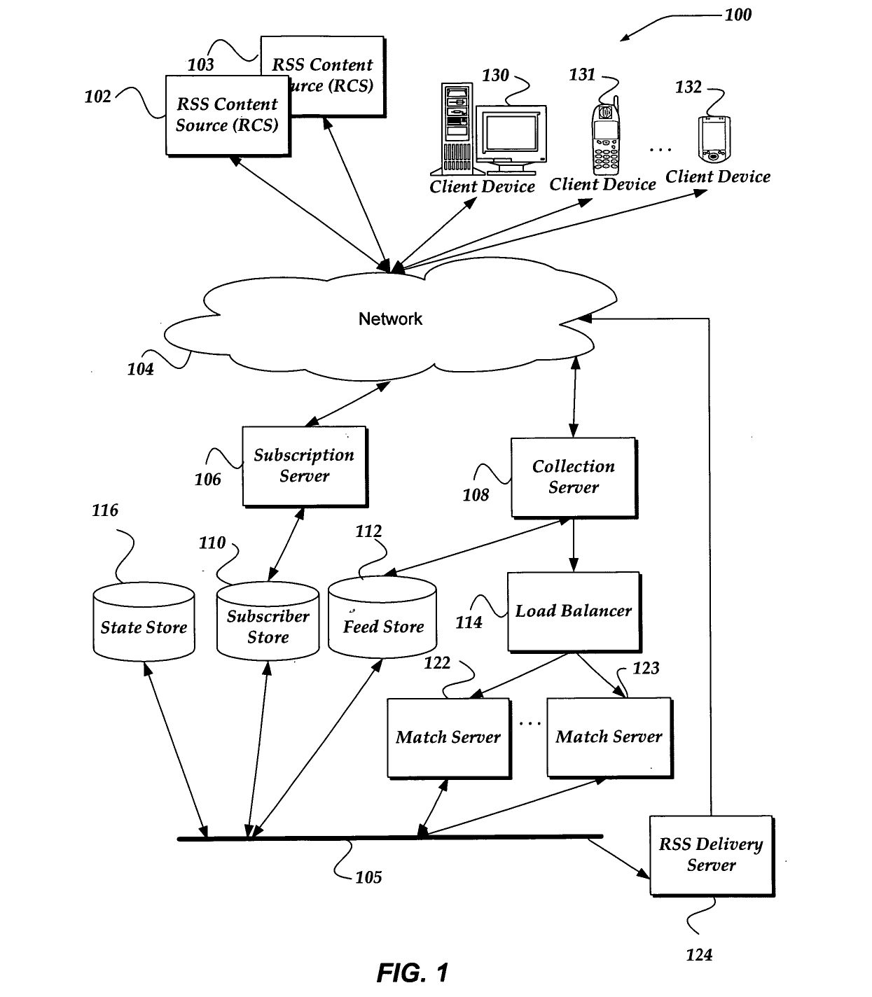

FIG. 1 shows components of an exemplary environment in which the invention may be practiced. Not all the components shown may be required to practice the invention, and variations in the arrangement and type of the components may be made without departing from the spirit or scope of the invention.

As shown in the figure, system 100 includes RCSs 102-103, client devices 130-132, networks 104-105, subscription server 106, collection server 108, load balancer 114, match servers 122-123, RSS delivery server 124, state store 116, subscriber store 110, and feed store 112.

Network 104 enables communication between RCSs 102-103, client devices 130-132, subscription server 106, and collection server 108. Subscription server 106 is also in communication with subscriber store 110. Collection server 108 is in communication also with feed store 112, and load balancer 114. Load balancer 114 is also in communication with match servers 122-123. Match servers 122-123 are in further communication with RSS delivery server 124, state store 116, subscriber store 110, and feed store 112.

Client devices 130-132 may include virtually any computing device that is configured to receive and to send information over a network, such as network 104. Such devices may include portable devices such as, cellular telephones, smart phones, display pagers, radio frequency (RF) devices, infrared (IR) devices, Personal Digital Assistants (PDAs), handheld computers, wearable computers, tablet computers, integrated devices combining one or more of the preceding devices, and the like. Client devices 130-132 may also include other computing devices, such as personal computers, multiprocessor systems, microprocessor-based or programmable consumer electronics, network PCs, and the like. As such, client devices 130-132 may range widely in terms of capabilities and features. For example, a client device configured as a cell phone may have a numeric keypad and a few lines of monochrome LCD display on which only text may be displayed. In another example, a web-enabled client device may have a touch sensitive screen, a stylus, and several lines of color LCD display in which both text and graphics may be displayed. Moreover, the web-enabled client device may include a browser application enabled to receive and to send wireless application protocol messages (WAP), and/or wired application messages, and the like. In one embodiment, the browser application is enabled to employ HyperText Markup Language (HTML), Dynamic HTML, Handheld Device Markup Language (HDML), Wireless Markup Language (WML), WMLScript, JavaScript, EXtensible HTML (xHTML), Compact HTML (CHTML), and the like, to display and send a message.

Client devices 130-132 also may include at least one client application that is configured to receive content from another computing device. The client application may include a capability to provide and receive textual content, graphical content, audio content, alerts, messages, notifications, and the like. Moreover, client devices 130-132 may be further configured to communicate a message, such as through a Short Message Service (SMS), Multimedia Message Service (MMS), instant messaging (IM), internet relay chat (IRC), mIRC, Jabber, Enhanced Messaging Service (EMS), text messaging, Smart Messaging, Over the Air (OTA) messaging, or the like, between another computing device, and the like.

Client devices 130-132 may also include a client application that is configured to enable a user of the device to subscribe to at least one RSS feed. Such subscription enables the user to receive through the client device an alert (or notification) that updated information is available for access. In another embodiment, the alert may include some or all of the updated information. Such updated information may include, but is not limited to, stock feeds, news articles, personal advertisements, shopping list prices, images, search results, blogs, sports, weather reports, or the like. Moreover, the alerts may be provided to client devices 130-132 using any of a variety of delivery mechanisms, including IM, SMS, MMS, IRC, EMS, audio messages, HTML, email, or another messaging application.

In some cases, a user could subscribe to an alert for certain content to be provided by all mechanisms available on the client device, and another alert for other registered content to be provided by a single delivery mechanism. Additionally, some alerts may be provided through RSS delivery server 124 with a push mechanism to provide a relatively immediate alert. In this case, the invention might employ stored subscriber profile information to deliver the alert to the user using a variety of delivery mechanisms. In contrast, other alerts can be provided with a pull mechanism where RSS delivery server 124 provides an alert and/or content in response to a request from a user. The requests can also be scheduled at predefined times to provide alerts.

For client devices 130-132 that may reside behind a Network Address Translation (NAT) device (not shown) over network 104, the pull mechanism may employ a connection established by a pull request to send the alert to the user. In one embodiment, how often the pull alert might be provided may be determined by a frequency with which a user makes a pull request for the alert and/or content.

The client application residing on client devices 130-132 may also be configured to store a history of alerts. In one embodiment, the client application may be a messaging application such as described above.

In one embodiment, client devices 130-132 may enable a user to operate the computing device to make requests for data and/or services from other computers on the network. Often, the requested data resides in computing devices such as RSS delivery server 124, RCSs 102-103, or the like. Thus, in this specification, the term “client” refers to a computer's general role as a requester of data or services, and the term “server” refers to a computer's role as a provider of data or services. In general, it is possible that a computer can act as a client, requesting data or services in one transaction and act as a server, providing data or services in another transaction, thus changing its role from client to server or vice versa.

RCSs 102-103 represent virtually any network available source of content that is configured to provide the source through an RSS feed mechanism. RCSs 102-103 may include businesses, blogs, universities, friends, news sources, or the like that may provide various content, including personal content, educational content, advertisements, business content, or any of a variety of other topical content. RCSs 102-103 may provide the content using either a push mechanism, and/or a pull mechanism. That is, in one embodiment, at least one RCS may provide content, an alert, or the like, to collection server 108 indicating that updated content is available for access. In another embodiment, at least one RCS may be pulled using a variety of mechanisms, including queries, or the like, by such as collection server 108, to determine availability of updated content. Moreover, at least one RCS may provide more than one RSS feed. Thus, for example, RCS 102, or the like, may provide an RSS feed associated with news, another for weather, another for editorials, or still another for traffic. However, clearly, an RCS is not constrained by these examples, and others may be used, and/or implemented, without departing from the scope or spirit of the invention.

Devices that may operate as RCSs 102-103 include personal computers, desktop computers, multiprocessor systems, microprocessor-based or programmable consumer electronics, network PCs, servers, or the like.

Networks 104-105 are configured to couple one computing device with another computing device. Networks 104-105 may be enabled to employ any form of computer readable media for communicating information from one electronic device to another. Also, networks 104-105 can include the Internet in addition to local area networks (LANs), wide area networks (WANs), direct connections, such as through a universal serial bus (USB) port, other forms of computer-readable media, or any combination thereof. On an interconnected set of LANs, including those based on differing architectures and protocols, a router acts as a link between LANs, enabling messages to be sent from one to another. Also, communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communication links known to those skilled in the art. Furthermore, remote computers and other related electronic devices could be remotely connected to either LANs or WANs via a modem and temporary telephone link.

Networks 104-105 may further include any of a variety of wireless sub-networks that may further overlay stand-alone ad-hoc networks, and the like, to provide an infrastructure-oriented connection. Such sub-networks may include mesh networks, Wireless LAN (WLAN) networks, cellular networks, and the like. Networks 104-105 may also include an autonomous system of terminals, gateways, routers, and the like connected by wireless radio links, and the like. These connectors may be configured to move freely and randomly and organize themselves arbitrarily, such that the topology of networks 104-105 may change rapidly.

Networks 104-105 may further employ a plurality of access technologies including 2nd (2G), 2.5, 3rd (3G), 4th (4G) generation radio access for cellular systems, WLAN, Wireless Router (WR) mesh, and the like. Access technologies such as 2G, 3G, and future access networks may enable wide area coverage for mobile devices, such as one or more of client devices 130-132, with various degrees of mobility. For example, networks 104-105 may enable a radio connection through a radio network access such as Global System for Mobile communication (GSM), General Packet Radio Services (GPRS), Enhanced Data GSM Environment (EDGE), Wideband Code Division Multiple Access (WCDMA), CDMA2000, and the like. Networks 104-105 may also be constructed for use with various other wired and wireless communication protocols, including TCP/IP, UDP, SIP, SMS, RTP, WAP, CDMA, TDMA, EDGE, UMTS, GPRS, GSM, UWB, WiMax, IEEE 802.11x, and the like. In essence, networks 104-105 may include virtually any wired and/or wireless communication mechanisms by which information may travel between one computing device and another computing device, network, and the like. In one embodiment, network 105 may represent a LAN that is configured behind a firewall (not shown), within a business data center, or the like.

Additionally, communication media typically embodies processor-readable instructions, data structures, program modules, or other data in a modulated data signal such as a carrier wave, data signal, or other transport mechanism and includes any information delivery media. The terms “modulated data signal,” and “carrier-wave signal” include a signal that has one or more of its characteristics set or changed in such a manner as to encode information, instructions, data, and the like, in the signal. By way of example, communication media includes wired media such as twisted pair, coaxial cable, fiber optics, wave guides, and other wired media and wireless media such as acoustic, RF, infrared, and other wireless media.

Subscription server 106 may include virtually any network device that is configured to provide an interface,for use with a client device, such as client devices 130-132 for managing an RSS-alert. In one embodiment, the interface may be a user interface. The user interface may be configured to enable a user to subscribe to an RSS feed, unsubscribe to an RSS feed, modify options associated with an RSS feed, or the like. In one embodiment, several user interface menus are arranged for the user to subscribe to an RSS feed based, in part, on whether the user accesses the user interface from a network location that includes associated RSS feed information, whether the user accesses subscription server 106 from a network location when there is no RSS feed information available, but the user may have already subscribed to at least one RSS feed, or whether the user has no current subscriptions to RSS feeds through subscription server 106. In any event, subscription server 106 may request from client devices 130-132, various subscriber profile information, including, but not limited to a user identifier (user-id), user name, alert type, alert sub-type, frequency of receiving the alert, mechanism to receive the alert, RSS feed associated with an alert, or other information. Subscription server 106 may store such subscriber profile information in subscriber store 110.

In one embodiment, subscription server 106 may be configured to provide an application programming interface (API), or the like, for use with a client device, such as client devices 130-132. Such API may include, but is not limited to, a web services interface, a remote procedure call (RPC) interface, or the like. The web services interface may include WSDL, SOAP-XML, or the like. The API may be configured to enable a client application running on a client device to subscribe to an RSS feed, unsubscribe to an RSS feed, modify options associated with an RSS feed, or the like.

Subscriber store 110 includes virtually any device that may be configured to receive and manage subscriber profile information, including, but not limited to a volatile and nonvolatile, removable and non-removable media implemented in any method or technology for storage of subscriber profile information, including processor readable code, instructions, data structures, program modules, or other data. Examples of processor readable storage media usable for subscriber store 110 include RAM, CD-ROM, DVD, optical storage, magnetic cassettes, magnetic tape, disk storage and/or any other magnetic storage devices, and/or any other medium that can store information that can be accessed by a computing device. Moreover, subscriber store 110 may be configured to employ a variety of mechanisms to manage subscriber profile information, including, documents, tables, files, scripts, applications, databases, spreadsheets, or the like.

Collection server 108 includes virtually any network device that may be configured to determine an availability of RCS content update for access by another computing device, such as client devices 130-132. Collection server 108 further provides information about the RCS content update to feed store 112, and through load balancer 114 to match servers 122-123. Devices that may operate as collection server 108 include personal computers, desktop computers, multiprocessor systems, microprocessor-based or programmable consumer electronics, network PCs, servers, or the like.

Collection server 108 may include a ping service, query mechanism, or the like, that is configured to determine whether an RCS content has been updated. In one embodiment, collection server 108 may listen for updates from a variety of pre-determined RSS feeds, such as from RCSs 102-103. In another embodiment, collection server 108 may receive a notification from RCSs 102-103, indicating that an update to content is available for access. In one embodiment, the notification is sent to collection server 108 using a ping type of mechanism that includes an identifier of the RSS feed. In one embodiment, the RSS feed identifier is an RSS URL. Moreover, in one embodiment, the notification of an RCS content update may also include the updated content.

Collection server 108 may also employ a crawler, such as a web crawler, RSS crawler, or the like, that is configured to search for RCS content updates over network 104. Collection server 108 may perform the crawls based on at least one pre-determined network address for an RSS content source. However, collection server 108 is not so limited. For example, collection server 108 may receive a search query for a type of content, such as from a subscriber, or the like, and perform the search query for the type of content over network 104. For example, in one embodiment, a subscriber may provide a Boolean query comprising of one or more logical operators, such as AND, OR, NOT, or the like, along with one or more search terms. Collection server 108 may provide the search query to a crawler for use in performing search for an RCS site, or the like, that may provide results that are similar to the search query. In any event, the results of crawling network 104 may be to identify RSS content sources that have an RCS content update. When such an RCS is located, collection server 108 may access the updated content.

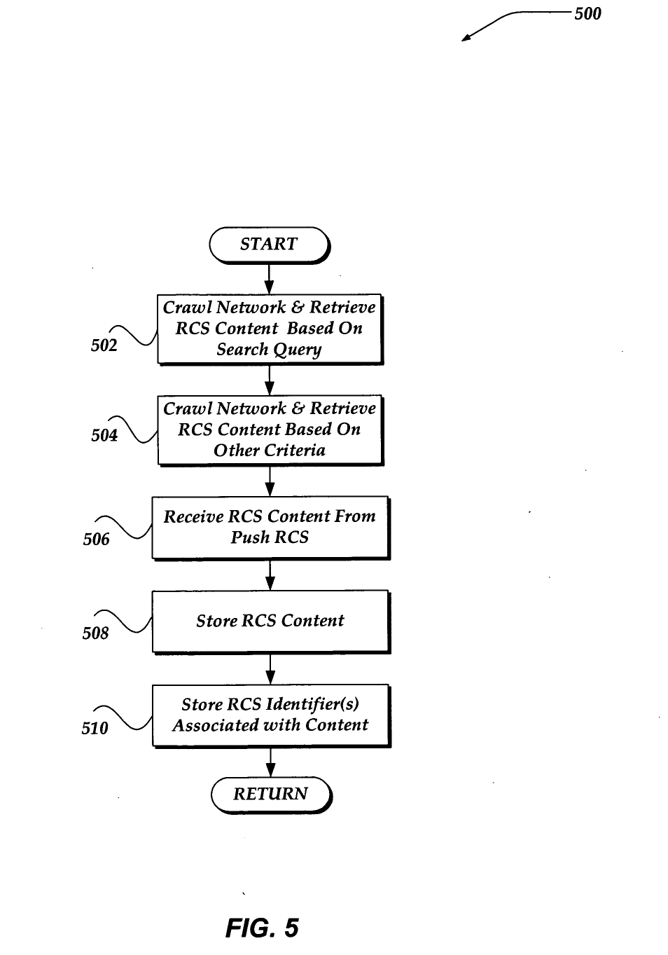

Collection server 108 may further search feed store 112 to determine whether the received content has already been received for an RCS. Content may be received by collection server 108 for any of a variety of reasons, including because an RCS may provide numerous notifications over a period of time for a same content update. Thus, if collection server 108 determines that the RCS content update has already been received, collection server 108 may select to drop the most recent update (e.g., duplicated content). If collection server 108 determines that the received notification is for a content update that has not been received, collection server 108 may provide the updated content to feed store 112 for storage. In addition, collection server 108 may also provide a notification of the update to load-balancer 114. In one embodiment, the notification to load-balancer 114 includes an identifier for the RCS having the updated content. In one embodiment, collection server 108 may generate an XML document which includes the RCS identifer. Moreover, in one embodiment, collection server 108 may employ a process substantially similar to process 500 described below in conjunction with FIG. 5 to perform at least some of its actions.

Feed store 112 includes virtually any processor readable storage media that may be configured to receive and manage RCS content. Examples of processor readable storage media usable for subscriber store 110 include RAM, CD-ROM, DVD, optical storage, magnetic cassettes, magnetic tape, disk storage and/or any other magnetic storage devices, and/or any other medium that can store information that can be accessed by a computing device. Moreover, feed store 112 may be configured to employ a variety of mechanisms to manage RCS content, including, documents, tables, files, scripts, applications, databases, spreadsheets, or the like. In one embodiment, feed store 112 may store the RCS content based, in part, on an RSS feed identifier. The RCS content may also include additional information associated with the RCS content, including, but not limited to a time stamp indicating when the RCS content was received.

Load-balancer 114 may include virtually any device that manages network traffic. Such devices include, for example, routers, proxies, firewalls, load balancers, cache devices, devices that perform network address translation, any combination of the preceding devices, and the like. Load-balancer 114 may be implemented using one or more personal computers, servers, multiprocessor systems, microprocessor-based or programmable consumer electronics, network PCs, radio frequency (RF) devices, infrared (IR) devices, integrated devices combining one or more of the preceding devices, and the like. Such devices may be implemented solely in hardware or in hardware and software. In one embodiment, load-balancer 114 may be implemented as at least one application residing within collection server 108. Moreover, although multiple load-balancers are not illustrated, the invention is not constrained to use of a single load-balancer. For example, multiple load-balancers may be implemented across distinct servers, multiple load-balancers may be implemented as multiple processes within a single server, or the like, without departing from the scope or spirit of the invention. Load-balancer 114 may be configured to control a flow of data delivered to an array of servers, such as match servers 122-123. In one embodiment, load-balancer 114 receives an XML document that may include an RSS URL associated with an RCS, such as RCSs 102-103. Load-balancer 114 may direct the document to a particular match server based on network traffic, network topology, capacity of a server, content requested, an authentication, or authorization status, and a host of other traffic distribution mechanisms. For example, in one embodiment, load-balancer 114 may distribute the XML documents across match servers 122-123 using a round-robin mechanism. However, other load-balancing mechanisms may also be employed, without departing from the scope or spirit of the invention. For example, load-balancer 114 may also control a flow of data based on an RSS feed identifier, RCS content type, a subscriber, a delivery type, or the like. In one embodiment, load-balancer 114 may be configured to deliver RSS feed identifiers based on a particular RCS content type, a subscriber, a delivery type, or the like.

One embodiment of a match server is described in more detail below in conjunction with FIG. 1. Briefly, however, match servers 122-123 include virtually any network device that may be configured to receive an indication of an RCS content update, and to create matches based, in part, on subscriber profile information, for the RCS content update and to send the matches to RSS delivery server 124 for distribution to the matched subscribers.

Match servers 122-123 may further employ state store 116 to determine, at least in part, whether a received RCS content update has been sent to the matched subscribers. If the RCS content update has already been sent, then match servers 122-123 may select to not send the matches to RSS delivery server 124. RCS content updates may have already been sent to the matched subscribers, for example, because one of the other match servers already sent the content update.

Devices that may operate as match servers 122-123 include personal computers, desktop computers, multiprocessor systems, microprocessor-based or programmable consumer electronics, network PCs, servers, or the like. Moreover, although multiple match server devices are illustrated, the invention is not constrained to multiple devices. For example, multiple match servers may be implemented as multiple processes within a single server device, without departing from the scope or spirit of the invention.

State store 116 includes virtually any processor readable storage media that may be configured to receive and manage state information associated with an RCS and related content. Examples of processor readable storage media include RAM, CD-ROM, DVD, optical storage, magnetic cassettes, magnetic tape, disk storage and/or any other magnetic storage devices, and/or any other medium that can store state information that can be accessed by a computing device. Moreover, state store 116 may be configured to employ a variety of mechanisms to manage state information, including, documents, tables, files, scripts, applications, databases, spreadsheets, or the like. In one embodiment, state store 116 may store the state information based, in part, on an RSS feed identifier. In one embodiment, the RSS feed identifier is a network address, such as a URL, or the like. State information may include, but is not limited to, a time stamp associated with when a match server received a last update to an RCS, and a hash of the content. Information within state store 116 may be managed by a state engine, not shown, collection server 108, or the like.

The hash of the RCS content may be used to determine whether a received content update is substantially different from another received content update. In one embodiment, the hash determined based on a Message Digest 5 (MD5) of at least a portion of the content. However, the invention is not constrained to MD5, and other one-way hash mechanisms may be employed, including MD2, MD4, Secure Hash Algorithm (SHA), N-Hash, Haval, or the like. Moreover, the hash may be performed by evaluating the received content update to determine whether the update represents a relevant update. This may be determined, for example, by examining the content for changes in the other than a title, a date on a feed, or the like. Thus, content updates considered to be substantive may be selected from content updates that may represent minor updates. For example, an update that merely changes a date or a title, or the like, for content, might be considered as not being substantive.

RSS delivery server 124 includes virtually any network device that is configured to prioritize and manage distribution of alerts to a client device, such as client devices 130-132. RSS delivery server 124 may receive information from match servers 122-123 indicating that pushed content, pulled content, or the like is available. RSS delivery server 124 may further receive from match servers 122-123 a user identifier indicating which subscriber to provide the alert. RSS delivery server 124 may receive alert content from feed store 112, and additional subscriber profile information from subscriber store 110 to determine when and how to deliver the alert to a subscriber.

As alerts are prepared and delivered, a monitor mechanism (not shown) may monitor the flow of alerts for patterns and/or other insights. For example, the monitor mechanism may track and/or access information about a subscriber's behavior, such as navigating to Web sites, making online purchases, and the like. The tracked behavior also may indicate a subscriber's interests which may also be stored in the subscriber's profile in subscriber store 110. When an alert is to be delivered, it may be routed to one or more appropriate servers (not shown) for delivery by the subscriber's preferred method(s). For example, email alerts can be delivered via bulk servers. Alerts to wireless mobile devices can be delivered via a wireless server. Instant message alerts can be delivered via an instant message server, and so forth. Each alert may be generally communicated over network 104 to a client device identified in the subscriber's profile. Thus, the subscriber can indicate that the alert be delivered to one ore more of a client devices.

In one embodiment, RSS delivery server 124 may also receive various customized templates that may be combined with the RCS alerts, RCS content, or the like. In one embodiment, RSS delivery server 124 may receive the customized templates from RCSs 102-103. In another embodiment, RSS delivery server 124 may receive the customized templates from a client device, such as one of the client devices 130-132. RSS delivery server 124 may employ a customized template based on the RCS, and/or a characteristic of a subscriber, or the like. For example, the customized template may be selected to provide additional information about the RCS. Thus, the customized template may include co-branding information associated with the RCS, a third party source, an advertisement selected by the RSS content and/or the RCS, an advertisement selected based on a client device type, or the like. In one embodiment, the customized templates may be in a form of a script, a web page with embedded scripting instructions, an extensible Stylesheet Language (XSL) transformation, or the like. In another embodiment, a subscriber's behavior, including what type of RSS content the subscriber has requested, or the like, may be employed to customize the RCS alert, the RCS content, or the like. In yet another embodiment, the templates may modify the RSS content, such modification including appending, deleting, correcting the content, or the like. The modifications may be also based on the RSS content and/or the RCS, an advertisement selected based on a client device type, or the like.

Although not illustrated, a mirror interface may be used to communicate with one or more mirrored components of system 100, including, but not limited to match servers 122-123, feed store 112, subscriber store 110, and/or state store 116. Thus, any, or all of system 100 may be reproduced for parallel processing, and/or failover processing. Such mirror interface may comprise one or more communication interfaces and/or associated network devices.

Illustrative Network Device

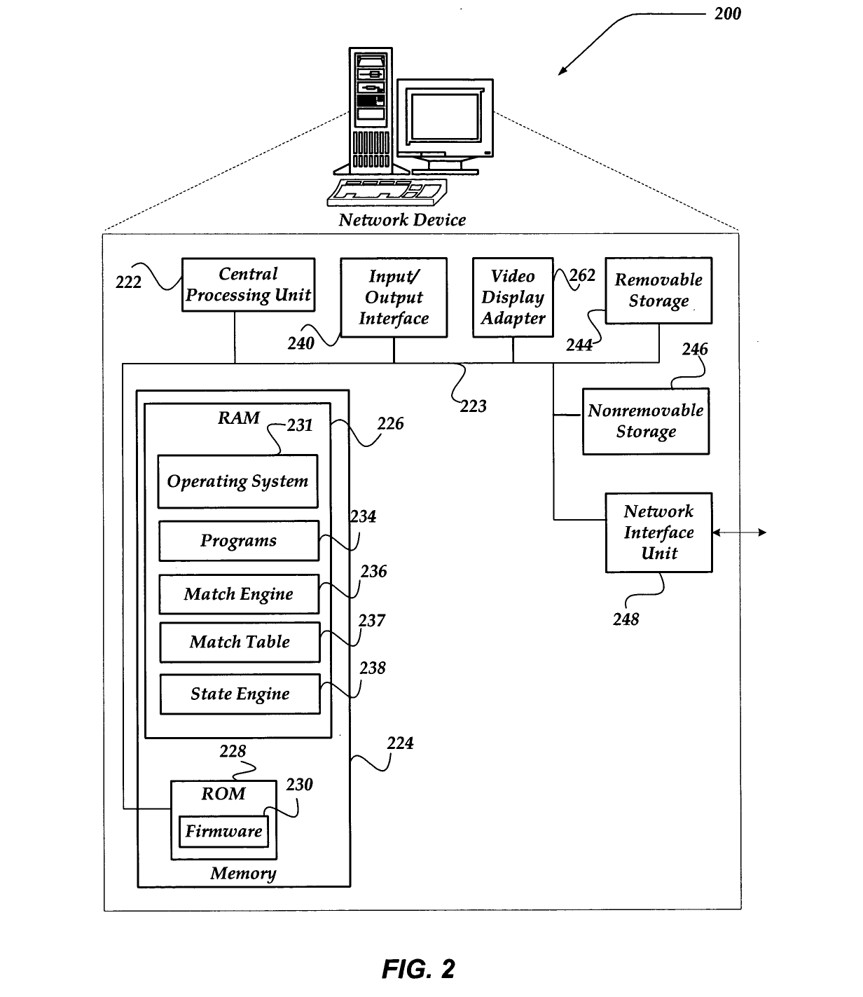

FIG. 2 shows an exemplary network device 200 that may operate as match server, such as match servers 122-123 of FIG. 1. It will be appreciated that not all components of network device 200 are illustrated, and that network device 200 may include more or less components than those shown in FIG. 2.

As shown in FIG. 2, network device 200 includes at least one central processing unit 222 in communication with main memory 224 by way of bus 223 or the like. Main memory 224 generally includes RAM 226, ROM 228, and may include other storage means, such as one or more levels of cache (not shown). Main memory 224 illustrates a type of processor-readable media, namely processor readable storage media. Processor readable storage media may include volatile and nonvolatile, removable and non-removable media implemented in any method or technology for storage of information, such as processor-executable instructions, data structures, program modules, and the like. Other examples of processor readable storage media include EEPROM, flash memory or other semiconductor memory technology, CD-ROM, DVD or other optical storage media, magnetic tape, magnetic disk storage or other magnetic storage devices, or any other medium that can be used to store the desired information and that can be accessed by a computing device.

Network device 200 includes an input/output interface 240 for communicating with input/output devices, such as a keyboard, mouse, printer, and the like. A user, such as a system administrator, or the like, of network device 200 may use input/output devices to interact by way of a user interface that may be separate from or integrated with operating system 231 and/or programs 234. Interaction with the user interface may include interaction by way of a visual display, using video display adapter 242.

Network device 200 may include secondary storage for storage of program modules, data, and the like not in main memory 224, including removable processor-readable storage 244 and/or non-removable computer-readable storage 246. Removable storage 244 may comprise one or more of optical disc media, floppy disks, and magnetic tape readable by way of an optical disc drive, floppy disk drive, and tape drive, respectively. Secondary storage may also include flash memory or other memory technology and generally includes any medium usable for storage of information and accessible by a computing device.

By way of network interface unit 248, network device 200 may communicate with a WAN, such as the Internet, a LAN, a wired telephone network, a wireless communications network, or some other communications network, such as network 105 of FIG. 1. Network interface unit 244 may comprise a transceiver, a network interface card, and the like. Network interface unit 244 is sometimes known as a transceiver, transceiving device, or network interface card (NIC).

Main memory 224 typically stores firmware 230 for boot-loading and controlling low-level operation of network device 200. Main memory 224 also stores programs for loading and execution by central processing unit 222, such as operating system 231 and other programs 234, which may include, for example, server applications, client applications, networking applications, messaging applications such as applications for RSS communication, and the like. Main memory 224 may further include match engine 236, match table 237, and state engine 238.

Match engine 236 is configured to receive information indicating that there is a content update available from an RCS. In one embodiment, match engine 236 may receive an XML document that includes an RSS feed identifier associated with the content update. Match engine 236 may employ match table 237 to determine whether at least one subscriber has subscribed to receive an alert for the RCS.

Match engine 236 may employ a variety of matching mechanisms to determine if at least one subscriber has subscribed to receive an alert. For example, in the matching mechanism may utilize a regular expressions list to map RSS feed identifiers and/or RCS content to at least one subscriber. In another embodiment, the matching mechanism may utilize a key word matching mechanism to perform the mapping. The key word matching mechanism may be, for example, an inverse index, a rule-base, or the like.

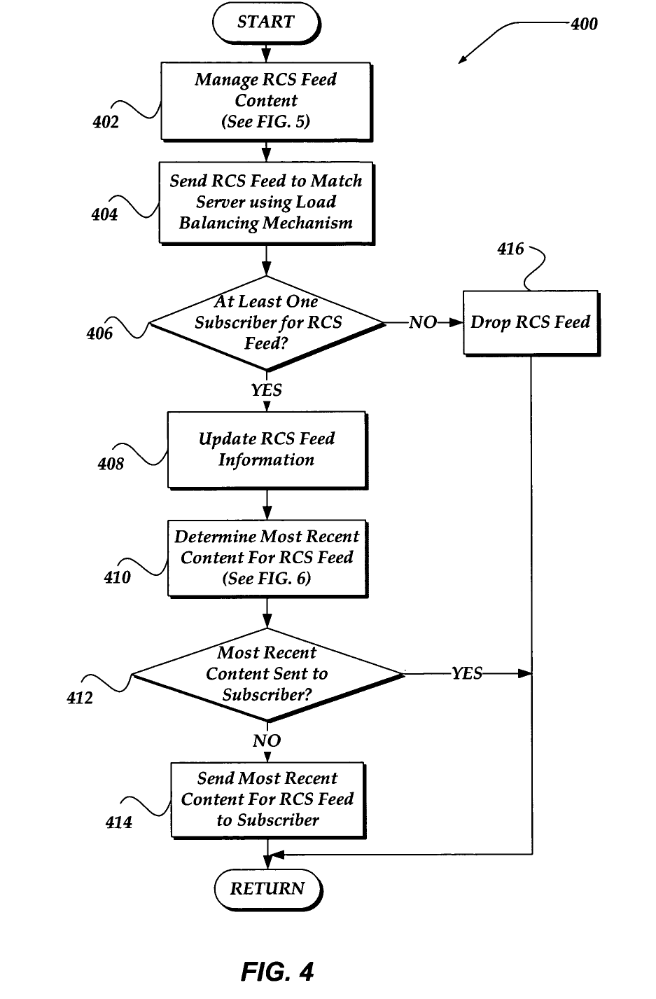

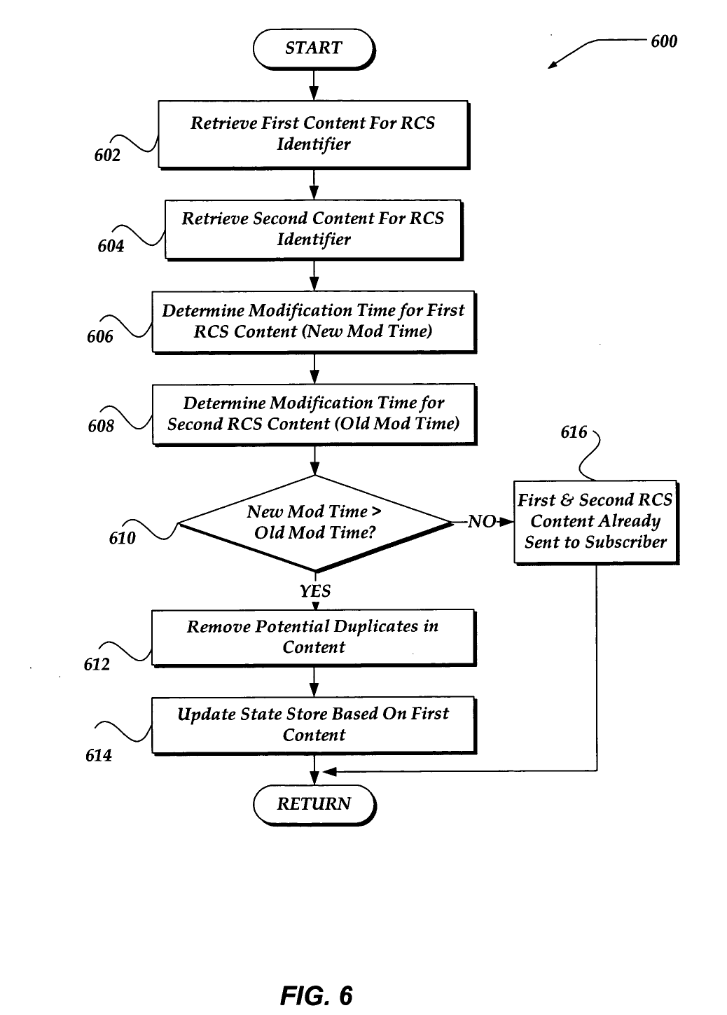

In any event, if match engine 236 determines that no subscriber requests an alert for the RCS, based, in part, on the RSS feed identifier, match engine 236 may drop the alert. Otherwise, match engine 236 may determine whether the received content update has been sent already to the at least one subscriber. In one embodiment, match engine 236 may request information from state engine 238 to determine whether the received content update has been sent already. If not, match engine 236 may obtain from match table 237 a list of the at least one subscriber that has requested an alert for the RCS. Match engine 236 may provide to such as a delivery server, or the like, the list of subscriber(s), along with the RSS feed identifier, and a request for delivery of an alert to the list of subscriber(s). Match engine 236 may employ a process substantially similar to at least a portion of process 400 of FIG. 4, and process 600 of FIG. 6, each of which are described below, to perform at least some of its actions.

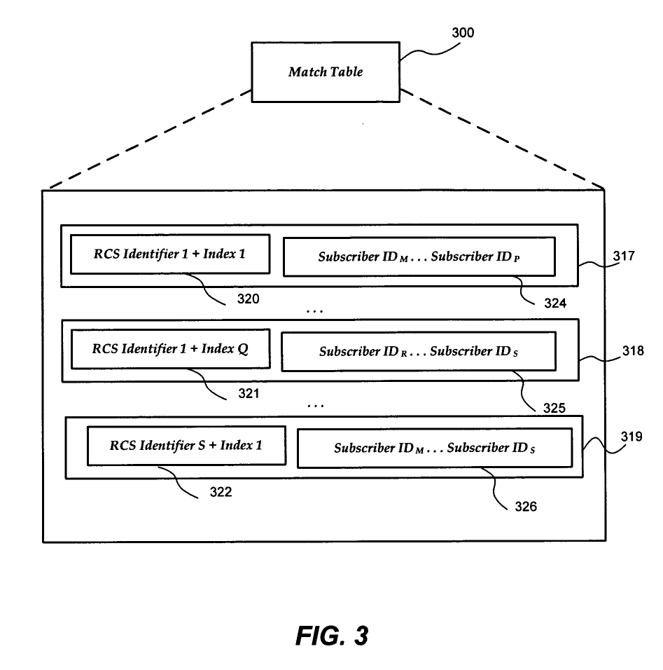

One embodiment of match table 237 is described in more detail below in conjunction with FIG. 3. Briefly, however, match table 237 includes RSS feed identifiers for RSS content sources for which at least one subscriber has requested an alert. Match table 237 may also include RSS feed identifiers for RSS content sources that a subscriber may be interested in, but has not yet requested an alert. Match table 237 also includes, for each RSS feed identifier, an identifier of a subscriber that has requested the alert for that RSS content source.

State engine 238 is configured to manage and retrieve information within a state store, such as state store 116 of FIG. 1. State engine 238 may retrieve from the state store information such a hash, time stamp, or the like, associated with a given RSS feed identifier. State engine 238 may provide the retrieved information to match engine 236 for use in determining whether a content update has already been sent to a subscriber for a given RSS feed identifier.

FIG. 3 shows one embodiment of a match table for use in managing RSS feeds to a subscriber. Not all the components shown may be required to practice the invention, and variations in the arrangement and type of the components may be made without departing from the spirit or scope of the invention. Match table 300 may be implemented using any of a variety of mechanisms, including, but not limited to a table, a database structure, a binary tree, a spreadsheet, or the like.

As shown, match table 300 includes a plurality of data structures 317-319. Each data structure 317-319 includes data fields comprising a key field (320-322) and a value field (324-326). Together, the key and value fields comprise a key-value pair for a given data structure.

Key fields 320-322 include an RSS feed identifier and potentially an index value. In one embodiment, the RSS feed identifier is a network address, such as an RSS-URL, or the like. Value fields 324-326 include at least one subscriber identifier for a subscriber that has requested an alert for the given RCS. As illustrated, data structures 317 and 318, together, include a list of subscribers, as shown in value fields 324 and 325 for RSS feed identifier 1. Thus, more than one data structure may be associated with a given RSS feed identifier. Data structure 322 includes within value field 326 a list of subscribers for RSS feed identifiers. As shown by subscriber IDS in both value field 325 and 326, a subscriber's identifier may be included for more than one RSS feed identifier.

In one embodiment, value fields 324-326 may be of a fixed-size. In one embodiment, value fields 324-326 may be configured to include about 100 subscribers' identifiers per field. In another embodiment, however, value fields 324-326 may be of variable size, enabling each of value fields 324-326 to include more, or less than about 100 subscribers' identifiers.

A new subscriber to a RSS feed identifier that already exists within match table 300 may be performed as follows. A search may be performed over the data structures associated with the RSS feed identifier to confirm that the subscriber's identifier is not already included. If subscriber's identifier is not already included, then a determination may be made as to which, if any of the value fields associated with the RSS feed identifier includes sufficient space to add the subscriber's identifier. If, each of the existing values are determined to be exhausted (e.g., insufficient space for another subscriber's identifier) then a new data structure may be created for the RSS feed identifier. The key field for that new data structure will include the RSS feed identifier plus an index value that is incremented over the existing indices for that RSS feed identifier. The subscriber's identifier is then included in the associated value field for the new data structure.

Deletion of a subscriber's identifier may be performed by locating the subscriber's identifier within a value field for the given RSS feed identifier, and removing its entry. If the removal results in a null value field for that data structure, the data structure may be deleted from match table 300. Moreover, where the data structure is deleted within a series of data structures for the given RSS feed identifier, the indices within the key field may be re-sequenced, although they need not be.

Generalized Operation

The operation of certain aspects of the invention will now be described with respect to FIGS. 4-6. FIG. 4 illustrates a logical flow diagram generally showing one embodiment of an overview process for managing an RSS alert to a plurality of subscribers over a network. As such, components of process 400 of FIG. 4 may be implemented within various components of system 100 of FIG. 1, including collection server 108, load-balancer 114, match servers 122-123, and/or RSS delivery server 124.

As shown in FIG. 4, process 400 begins after start block, at block 402. Block 402 is described in more detail below in conjunction with FIG. 5. Briefly, however, at block 402 content from an RSS feed is managed. In one mode, RSS feed content may be received through a notification from an RCS. In another mode, a crawler, search engine, or the like, may be employed to search for, identify, and retrieve RSS feed content. It should be clear that while updated content is expected. That is retrieved RSS feed content is expected to be substantively different from previously retrieved content. However duplicate content or substantially similar content may also be received. This may arise for any of a variety of reasons including the RSS feed has not updated its content since a previous search was performed; the RSS feed has provided duplicate content; the RSS feed made minor changes to the content such as a change in a title, an author, a spelling correction, or the like.

Processing then flows to block 404, where the RSS feed is sent to a match engine using a load-balancing mechanism. Any of a variety of load-balancing mechanisms may be employed, including those described above.

Process 400 continues next to decision block 406, where a determination is made whether there is at least one subscriber that has requested an RSS alert for the RSS feed. If no, subscriber has requested an RSS alert for the RSS feed, processing flows to block 416, where the RSS feed and its received content may be dropped. Processing then may return to a calling process to perform other actions.

However, if at decision block 406, at least one subscriber has requested an RSS alert for the RSS feed, processing flows to block 408. At block 408 an update is performed based on the received content from the RSS feed. In one embodiment, the update includes updating a time stamp associated with the content from the RSS feed, updating a hash value associated with at least a pre-determined portion of the content from the RSS feed, or the like.

Processing then continues to block 410, where recent content for the RSS feed is determined. Block 410 is described in more detail below in conjunction with FIG. 6. Briefly, however, a result of block 410 includes whether the most recent content for the RSS feed has already been sent to a subscriber. Processing flows next to decision block 412, where a determination is made whether the most recent content for the RSS feed has already been sent to the subscriber. If it has, processing returns to the calling process to perform other actions. Otherwise, process continues to block 414, where the recent content for the RSS feed is sent to the subscriber. In one embodiment, recent content at the RCS, a list of subscribers, an RSS feed identifier, and the like, is provided to a delivery component that is configured to send an RSS alert to the list of subscribers. The RSS alerts may be sent to the list of subscribers using any of a variety of mechanisms, as described above. Processing then returns to the calling process to perform other actions.

FIG. 5 illustrates a logical flow diagram generally showing one embodiment of a process for collecting content for RSS feeds. Process 500 of FIG. 5 may be implemented for example, within collection server 108 of FIG. 1. Moreover, process 500 may represent one embodiment of a process called from block 402 of FIG. 4.

Process 500 begins, after a start block at block 502, where a crawler may be employed to crawl a network, such as the Internet, or the like, to locate and retrieve RCS content based on a search query. Thus, in one embodiment, a subscriber may request an RSS alert for content that substantially satisfies a query. Such queries may be provided directly into a user interface provided by a component of system 100 of FIG. 1, such as subscription server 106. In one embodiment, subscription server 106 may receive from the subscriber a structured query language search request. Subscription server 106 may then employ a search tool that crawls the network for RSS feeds that substantially satisfy the structured query. In any event, if an RSS feed is located that includes content that substantially satisfies the search query, an action may be performed that may include registering for the RSS feed, obtaining an RSS feed identifier associated with RCS, accessing the content, or the like.

Processing then flows to block 504 where other criteria may be employed to perform a search for and retrieval of content from an RSS feed over the network. Such other criteria, may include, but is not limited to, crawling the network based on a pre-determined search query that may be available to a plurality of subscribers, a selection of a feed type, a subscriber behavior, or the like. In any event, again, if an RSS feed is located that includes content that substantially satisfies the other search criteria, action may be performed that may include registering for the RSS feed, obtaining an RSS feed identifier associated with RCS, accessing the content, or the like.

Processing continues to block 506, where notifications or the like, are received from RSS feeds that may already be registered with at least one subscriber. In one embodiment, process 506 may also receive notifications from an RSS feed for which no subscriber is currently registered to receive an alert. However, in any event, both types of RSS feeds typically provide a push type notification indicating that content is available for access. Thus, content may be received from these RSS feeds, along with an associated RSS feed identifier, or the like.

Process 500 flows next to block 508 where the received content for the RSS feed may be stored in such as feed store 112 of FIG. 1, or the like. Processing continues next to block 510 where the RSS feed identifiers associated with the content may also be stored. Process 500 then returns to a calling process to perform other actions. In one embodiment, process 500 may return to process 400 of FIG. 1.

FIG. 6 illustrates a logical flow diagram generally showing one embodiment of a process for determining whether to send an RSS feed alert and/or the content to a subscriber. Process 600 of FIG. 6 may be implemented, for example, within a match server, such as match servers 122-123 of FIG. 1. Moreover, in one embodiment, process 600 may represent a process that is called from block 410 of FIG. 4.

Process 600 begins, after a start block, at block 602, where a first content for a given RSS feed identifier is retrieved. Processing continues to block 604, where a second content is retrieved for the given RSS feed identifier. In one embodiment, the first and second content may be retrieved from a store, such as feed store 112 of FIG. 1, or the like.

Processing flows next to block 606 where a modification time (New Mod Time) for the first RCS content is determined. In one embodiment, the new modification time represents a time when the first RCS content was modified by the RCS. This may be indicated, for example, by a time stamp that is received from the RCS. In another embodiment, the new modification time represents a time when the first RCS content was retrieved. In any event, processing continues to block 608, where a modification time (Old Mod Time) for the second RCS content is determined. As above, the old modification time may represent a time when the second RCS content was modified by the RCS, a time when the second RCS content was retrieved. In still another embodiment, the old modification time may represent a time when the second RCS content was prepared for delivery to at least one subscriber.

Processing continues next to decision block 610, where a determination is made whether the New Mod Time is greater than the Old Mod Time. The New Mod Time might not be greater for a variety of reasons. For example, there was a false notification from the RSS feed, multiple search queries resulted in substantially similar content being retrieved from the RSS feed, or the like. Other reasons may be that the RSS feed's content may not have been updated or another match engine received the RSS feed's content and already sent it out for delivery to a subscriber, or the like. In any event, if it is determined that the New Mod Time is greater than the Old Mod Time then processing flows to block 612; otherwise, processing flows to block 616, where it is recognized that the first RCS content has already been sent to the subscriber. Processing thus returns to a calling process to perform other action.

At block 612, potential duplicates in the RCS content may be removed. In one embodiment, a comparison may be performed between hashes of RCS content within a feed store, state store, or the like. Processing moves next to block 616, where state information may be updated for the first RCS content. Such state information update may include for example, updating a time stamp, or the like. Process 600 then returns to the calling process to perform other actions.

It will be understood that each block of the flowchart illustration, and combinations of blocks in the flowchart illustration, can be implemented by computer program instructions. These program instructions may be provided to a processor to produce a machine, such that the instructions, which execute on the processor, create means for implementing the actions specified in the flowchart block or blocks. The computer program instructions may be executed by a processor to cause a series of operational steps to be performed by the processor to produce a computer implemented process such that the instructions, which execute on the processor to provide steps for implementing the actions specified in the flowchart block or blocks.

Accordingly, blocks of the flowchart illustration support combinations of means for performing the specified actions, combinations of steps for performing the specified actions and program instruction means for performing the specified actions. It will also be understood that each block of the flowchart illustration, and combinations of blocks in the flowchart illustration, can be implemented by special purpose hardware-based systems which perform the specified actions or steps, or combinations of special purpose hardware and computer instructions.

The above specification, examples, and data provide a complete description of the manufacture and use of the composition of the invention. Since many embodiments of the invention can be made without departing from the spirit and scope of the invention, the invention resides in the claims hereinafter appended.

What is claimed as new and desired to be protected by Letters Patent of the United States is:

1. A method of managing content for Really Simple Syndication (RSS) over a network, comprising:
determining content associated with an RSS feed;
determining an identifier for the RSS feed;
if a change is determined for content associated with the RSS feed, load balancing a determining of an association of the RSS feed to at least one of a plurality of subscribers based at least in part on the identifier; and
providing an RSS alert of the change in content to at least one subscriber that is associated with the RSS feed.

2. The method of claim 1, further comprising crawling the network to determine an availability of content associated with the RSS feed.

3. The method of claim 1, further comprising receiving a notification of content associated with the RSS feed.

4. The method of claim 1, wherein the load balancing further comprises performing load balancing actions based at least in part on one of round-robin, hops, latency, priority, bandwidth, capacity, RSS Content Source (RCS), identifier, RCS content type, subscriber, or type of delivery.

5. The method of claim 1, further comprising retrieving content for the RSS feed based on a search query.

6. The method of claim 1, further comprising determining if a subscriber is associated with the RSS feed based in part on at least one data structure having a key field and a value field, wherein the key field includes the identifier and the value field includes at least one other identifier for a particular subscriber.

7. The method of claim 1, further comprising providing the RSS alert if the change in content is unduplicated by other content previously associated with the RSS feed.

8. A system for managing content for Really Simple Syndication (RSS) over a network, comprising:
a collection component that is operative to perform actions, including:
determining content associated with an RSS feed;
determining an identifier associated with the RSS feed that is further associated with the determined content; and
a load balancer that is arranged to load balance the forwarding of the identifier to one of a plurality of match servers if a change in the content occurs,;
a match server that is arranged to receive the forwarded identifier and is operative to determine an association of the RSS feed with at least one subscriber based at least in part on the identifier; and
a delivery server that is arranged to forward an RSS alert to at least one subscriber that is determined to be associated with the RSS feed if content associated with the RSS feed is changed.

9. The system of claim 8, wherein the load balancer is arranged to perform load balancing actions based on at least one of round-robin, hops, latency, priority, bandwidth, capacity, RSS Content Source (RCS), identifier, content type, subscriber, or type of delivery.

10. The system of claim 8, further comprising determining an availability of content for the RSS feed based on at least one of receiving a notification associated with the RSS feed, or crawling the network for content associated with the RSS feed.

11. The system of claim 8, wherein the RSS alert is accessible to the subscriber with at least one of a personal computer, network appliance, or a mobile device.

12. The system of claim 8, wherein the collection component performs further actions including providing the identifier to the match server if content is unduplicated by other content previously associated with the RSS feed.

13. The system of claim 12, further comprises comparing a hash of at least a portion of the content to a hash of at least a portion of the other content to determine if the change in content is duplicative.

14. The system of claim 8, wherein the RSS alert is forwarded to the subscriber in at least one format, including, including email, Instant Messaging (IM), relay, chat, text message, Short Message Service (SMS), or Multi-media messaging.

15. A server that is operative to manage content for Really Simple Syndication (RSS) over a network, comprising:
a memory component for storing data;
a processing component for executing data that enables actions, including:
determining an availability of content associated with an RSS feed;
determining an identifier for the RSS feed;
if a change in content associated with the RSS feed is determined, load-balancing a determination for an association of the RSS feed to at least one of a plurality of subscribers based at least in part on the identifier; and
enabling an RSS alert to be provided to at least one subscriber that is associated with the RSS feed if the change in content occurred.

16. The server of claim 15, wherein the processing component enables further actions comprising:
comparing a first time period associated with RSS feed content to a second time period associated with other RSS feed content; and
if the first time period is more recent than the second time period, providing at least one indication that the change in content associated with the RSS feed occurred.

17. The server of claim 15, wherein the processing component enables further actions comprising determining if a subscriber is associated with the RSS feed based in part on a search for the identifier in a key field in at least one key-value pair for a plurality of key-value pairs.

18. The server of claim 15, wherein the RSS alert is forwarded to the subscriber in at least one format, including email, Instant Messaging (IM), relay, chat, text message, Short Message Service (SMS), or Multi-media messaging.

19. The server of claim 15, wherein the processing component performs further actions including enabling the RSS alert to be provided if the change in content is unduplicated by other content previously associated with the RSS feed.

20. A client that is operative for managing content for Really Simple Syndication (RSS) over a network, comprising:
a memory component for storing data; and
a processing component for executing data that enables actions, including:
enabling an RSS alert to be provided to at least one subscriber that is associated with an RSS feed; and
wherein the RSS alert indicates an occurrence of change in content associated with the RSS feed; and wherein the association of the RSS feed to the at least one subscriber is load balanced based at least in part on an identifier that is determined to be associated with the RSS feed.

21. The client of claim 20, wherein the processing component performs further actions including enabling the RSS alert to be provided to the at least one subscriber if the change in content is unduplicated by other content previously associated with the RSS feed.

22. The client of claim 20, wherein the RSS alert is forwarded to the at least one subscriber in at least one format, including email, Instant Messaging (IM), relay, chat, text message, Short Message Service (SMS), or Multi-media messaging.

23. The client of claim 20, wherein the RSS alert is provided for access by the subscriber with at least one of a personal computer, network appliance, or a mobile device.

24. A processor readable medium that includes data, wherein the execution of the data provides for the management of RSS content over a network by enabling actions, including:
determining an availability of content associated with an RSS feed;
determining an identifier for the RSS feed;
if a change in content associated with the RSS feed is determined, load-balancing the determining of the association of the RSS feed to at least one of a plurality of subscribers based at least in part on the identifier; and
providing an RSS alert to at least one subscriber that is determined to be associated with the RSS feed if the change in content occurs.
